(19) United States
(12) Patent Application Publication
(10) Pub. No.: US 2004/0220686 A1
(43) Pub. Date: Nov. 4, 2004

(54) Electronic training aide

(76) Inventor: Steve Cass, Frewsburg, NY (US)

Correspondence Address: HESLIN ROTHENBERG FARLEY & MESITI PC, 5 COLUMBIA CIRCLE, ALBANY, NY, 12203, US

(21) Appl. No.: 10/184,292

(22) Filed: Jun. 27, 2002

(51) Int. Cl. G06F 17/00

(52) U.S. Cl. 700/94

(57) ABSTRACT

An electronic training aide to assist an individual in the proper reproduction of wildlife sounds. Animals communicate with each other using different sounds. For example, a turkey may use as many as 15 different sounds to communicate. Some sounds may indicate danger, while other sounds signal safety. Hunters, photographers and wildlife aficionados spend countless hours trying to accurately replicate wildlife sounds on calls. The invention is an electronic device specific to the various calls of individual wildlife calls and sounds for a specific animal. The device includes a series of buttons and activating each button reproduces a specific call such as alarm call, lost call, feeding call, hail call, come back call, etc for each animal. The person could activate the particular call with a button and continue to learn each individual call by repetition.

### FIELD OF THE INVENTION

The present invention is directed to an electronic training aide to assist an individual in the proper reproduction of wildlife sounds.

### BACKGROUND OF THE INVENTION

Presently, there are many devices in use today to attract wildlife. These devices are used to entice deer, moose, elk, birds, water fowl, turkeys and even predators, such as coyotes and wolves. Hunters, photographers and wildlife aficionados buy new calls each year in an attempt to accurately reproduce the sound of an animal. Game call users have different attributes, calling abilities and preferences. A call in the hands of one individual will sound much different than in the hands of another. Tones may vary by pitch and volume and individuals may change their method of calling. Another problem is game calls wear down, get old and the sound deteriorates. Individuals need assistance in reproducing animal and wildlife sounds.

There are numerous devices in use today for reproducing wildlife sounds. Some devices are created by friction or an individual blowing air into an apparatus and some devices are electronic recording and playback devices. For instance, U.S. Pat. No. 5,802,197 issued Sep. 1, 1998 to Fulcher discloses an audio decoy device. The device is used to lure game for a hunter with a myriad of animal sounds on the one device. With a single audio decoy device the user could generate duck quacking calls, gobbling turkeys or other animal sounds.

This device is not an audio decoy; rather it takes the numerous calls and makes the individual sounds with a playback feature. It thus acts as a training device to allow a hunter, photographers and wildlife aficionados to practice and learn that individual call through repetition.

U.S. Pat. No. 5,964,054 issued Oct. 12, 1999 to Galfidi speaks of an electronic game call attached to an archery bow with a caller mounted on a hunter's belt as a luring device. The electronic training aide would not be mounted to a bow as a luring device it would more importantly take the appropriate level of volume, specific and individual calls for each animal and be used as a training device.

U.S. Pat. No. 5,239,587 issued Aug. 24, 1993 to Mucklerath is a recording device placed in an open area frequented by wildlife. The device records wildlife sounds and includes a time-stamp for identifying when the recorded sounds were made allowing a hunter to determine if a specific area has a sufficient number and type of game. The electronic training aide does not record, rather it takes specific animal sounds and plays them over and over again as a training aide.

### SUMMARY OF THE INVENTION

The present invention includes a training aide to assist hunters, photographers and wildlife aficionados in the accurate reproduction of wildlife sounds. The present invention includes digitally recorded wildlife sounds or calls of a specific animal and include a playback feature for the specific sounds. The invention assists an individual in learning how to accurately reproduce the wildlife sounds. Moreover, the wildlife or animal sounds includes more than one call per species, namely, specific calls of each animals. For example, the come back call, the hail call, the feeding call of a mallard duck, the kiki run, cluck, purr and yelp of a turkey, etc. By using digitally recorded sounds, the user will have the opportunity to listen to clear characterizations of actual different real animal calls for a single species. The electronic training device could be used for hunting where permitted. Further, the user shall simply take a device specific to each animal and can practice specifically working on one of the many calls by activating an individual button on that device. The device may be small and may be battery powered to offer portability.

The electronic training aide of the present invention differs from the prior art in three ways:

a. Each device would have various individual calls for each specific animal. For example, the hail call, the come back call, the feeding call of a mallard duck, or the cluck, the yelp, the purr and the kiki run of a turkey.

b. The device would be used as a training aid to teach individuals the unique and individual different calls of each animal. Although the device could be used for hunting where permitted

c. The device would have the appropriate volume, since it may use live recordings.

d. The device may include activator buttons for the different specific calls. When a second activator button is pushed, the existing sound call being played, if any, will be interrupted and the new sound call corresponding to the second activator button will be played.

It is a principal object of the invention to provide a training device for individuals to learn to reproduce animal or wildlife sounds.

It is another object of the invention to provide an inexpensive training aide for reproducing the sounds.

It is another object of the invention to reproduce actual animal sounds with extreme clarity.

It is another object of the invention to provide a portable device for the user.

It is another object of the invention to use numerous calls and sounds of each animal.

It is another object of this invention to use the appropriate level of volume.

These and other objects of the invention will become apparent upon further review of this specification and drawings.

### BRIEF DESCRIPTION OF THE DRAWINGS

FIG. 1 is a perspective view of the electronic training aide of the present invention;

FIG. 2 is an exploded perspective view of the electronic training aide of the present invention;

FIG. 3 is a schematic view of the electronic training aide of the present invention.

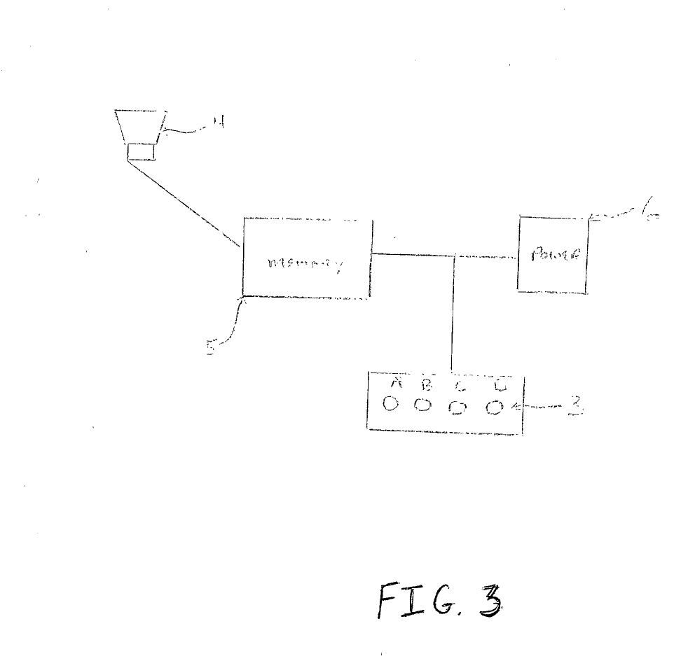

### DETAILED DESCRIPTION

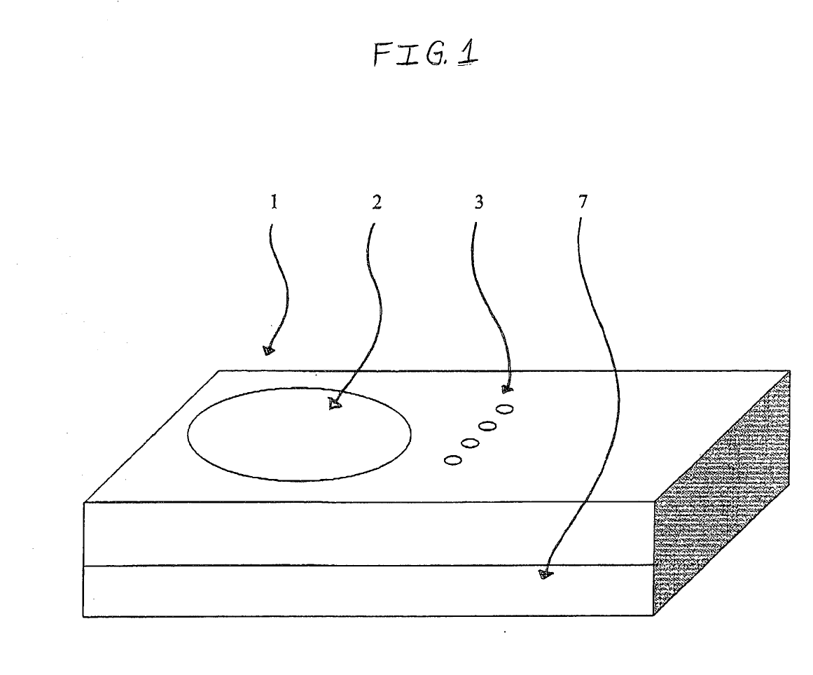

FIG. 1 shows the electronic training aide with the housing unit 1 and 7 connected.

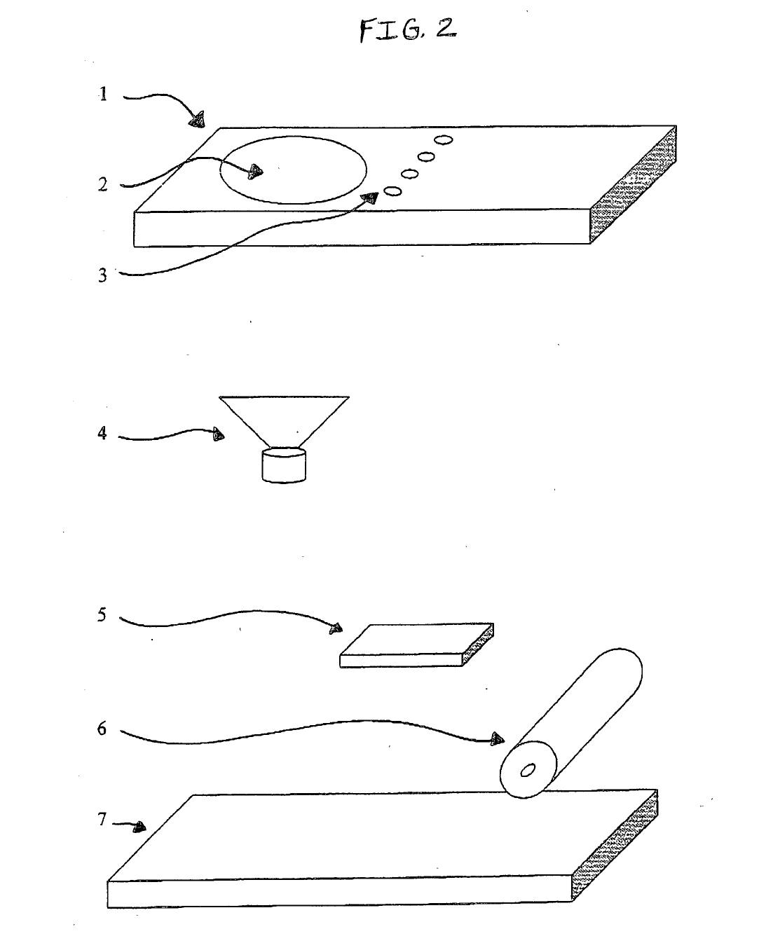

FIG. 2 depicts the training aide contained in a housing with an upper compartment 1, and a lower compartment 7. The top of the housing 1, has a perforated circular area 2, to allow the sound from the speaker 4, to exit through the housing 1. The rectangular housing 1, is typically a snap-on or force-fit retainer which connects to the bottom compartment 7. The housings 1 and 7 are hard plastic that protects the speaker 4, and contents from damage.

FIG. 2 illustrates the internal components of the invention. Activator buttons 3, are set forth on the outside of the housing 1, and can be pushed externally. The activator buttons 3, are connected to circuit board 5, allowing the user to push the selected call of the animal chosen. The circuit board contains an integrated circuit or chip containing a memory for storing digital animal call sounds. These call sounds can be actual recordings of the animal sounds, digitally created or synthesized sounds and/or man-made wildlife calls.

Speaker 4, is connected in housing 1, so that sound may exist through the perforated area of the housing 2. Activator buttons 3, are connected to the circuit board 5, and powered by the battery 6. When the activator button 3 is depressed, there is electronic communication with a digital audio sound recording circuit board 5 which emits the selected animal sound chosen by one of the activator buttons 3.

At the bottom of housing 7, is a power source compartment for holding, for example, a battery 6, to provide power to the circuit board. The battery access is in a standard conventional manner known to those skilled in the art with appropriate power ratings.

The memory may contain digitally recorded wildlife sounds and calls of the specific animal and store the sounds on one device for each animal. The user could push the different activator buttons 3 on the device to produce different sounds unique to that animal. This could be used for hunting or to allow an individual to practice and properly reproduce that animal sound. The device would be developed to include but not be limited for animals such as the antelope, bear, coyote, crow, deer (white tail and mule), ducks, elk, geese, hawks, quail, javelina, moose, owls, pheasants, predators, squirrels, rabbits, raccoons, turkeys, songbirds, woodpeckers, etc.

The various calls specific to each animal have many different names which shall include but not be limited to

antelope: feeding call, mating call, grunt, bleat, blat, young distress call

bear: feeding call, mating call, grunt, bleat, blat, young distress call

bobcat: mew, purr, snarl, mating call, young distress call

coyote: feeding call, mating call, grunt, bleat, blat, young distress call, squeak, howl, yip, bark, assembly call, yelp

dove: coo

crow: feeding call, mating call, grunt, bleat, blat, young distress call, riot call, assembly call, alarm call, baby crow call, lost call

deer (white tail and mule): feeding call, mating call, grunt bleat, blat, mew, whine, young distress call, snort

ducks: feeding call, hail call, comeback call, greeting call, cluck, moans, quack, mating call, assembly call, lost call, whistle (this shall include all ducks in the United States i.e., puddle ducks, diver ducks, wood ducks etc.)

elk: breeding call, mew, bugle, bark, whine, grunt, chirp, calf call, distress call, cow call yodel, chuckle, growl, squeals, blat, bleat, mating call, distress call

geese: cluck, murmur, moan, hail call, greeting call, intermediate hail call, comeback call, laydown call, feeding call

hawks: screech, mating call, lost call, young distress call

quail: assembly call, lost call, cluck, feeding call, distress call

javelina: grunt, squeal, mating call, assembly call, distress call

lynx: mew, purr, snarl, mating call, young distress call

moose: grunt, feeding call, mating call, bleat, blat, young distress call

mountain lion: mew, purr, snarl, mating call, young distress call

owls: hoot, screech, mating call, assembly call, lost call

partridge: feeding call, mating call, assembly call, cluck, drum

pheasants: cackle, cluck, yelp, mating call, assembly call

predators: bark, yelp, grunt, assembly, feeding call, distress call, lost call

squirrels: young distress call, bark, chatter, whistle, assembly, feeding call, chirp

rabbits: distress call, squall, mating call, assembly call

raccoons: squalls, hiss, bark

turkeys: cluck, yelp, gobble, kiki run, whistle, cackle, tree yelp, purr, assembly call, putt, cutt

songbirds: feeding call, assembly call, lost call, mating call, twitter, chirp, warble, chortle, carol, sing, call

sandhill crane: feeding call, assembly call, lost call, mating call, twitter, chirp, warble, chortle, carol, sing, call

swan: feeding call, assembly call, lost call, mating call, twitter, chirp, warble, chortle, carol, sing, call

woodpeckers: feeding call, assembly call, lost call, mating call, twitter, chirp, warble, chortle, carol, sing, call, drum

The user may select the type of animal by sound to play by selecting an appropriate device with that animal's various calls stored in memory and thereafter can depress one of the activator buttons 3 to reproduce desired calls of the individual animal. For example, one electronic training aide could contain exclusively the various types of turkey calls stored in memory. Also, one activator button on that device would produce the lost call of a turkey. The second button on the same device would produce the yelp of a turkey, the third button would produce the purr of a turkey, and the last button on that device would reproduce the kiki run of a turkey. The electronic training device could have more or less than four activator buttons and could be used for hunting purposes where permitted. Of course, many devices may be created each housing the different types of calls of one particular animal species stored therein in memory.

The device as shown in diagram 1 may be hand held and activated by pushing one of the activator buttons 3. The buttons may be marked with a designation indicative of the particular call. If desired, the device may be construed and used so that if a second activator button is depressed during the emission of a sound call. The sound call will be interrupted and stopped, and a new sound call corresponding to the second activator button will be played. Thus, for example, if a device including various turkey calls and an activator button is depressed to play a yelp, the user may press a second activator button to interrupt the yelp call, stop the yelp call and play a cluck call, for example. Also, a volume control may also be included. Thus, the electronic training aide provides a simply constructed portable training aide. The device would allow a user to listen to authentic various calls of individual animals thereby allowing the operator to mimic a call.

There may be other improvements, modification and embodiments apparent upon review of this disclosure. As such, these changes are considered to be within the scope of this invention as defined in the claims and equivalents thereof.

Further, the invention illustrated and described in the drawings and description is considered as illustrative and not restrictive in character and scope. The housing, as shown at 1, may be adapted to accommodate different shapes such as cylindrical, triangular, etc. It is to be understood that the present invention is not limited to the embodiments described above, but encompasses any and all embodiments within the scope of the claims.

1. An electronic device for the reproduction of wildlife sounds comprising:
a memory having digital audio sounds stored therein, said digital audio sounds comprising a plurality of different calls for the same particular species of animal;
activator means coupled to said memory adapted to play one or more of said different calls.

2. The electronic device of claim 1 wherein said plurality of different calls for the same particular species of animal comprises at least two of a lost call, assembly call, greeting call, alarm call, feeding call, yelp, cluck, purr, hail call, come back call and safety call.

3. The electronic device of claim 2 further comprising a speaker electronically coupled to said memory.

4. The electronic device of claim 1 further comprising an activator means coupled to said memory, said activator means comprising one or more buttons.

5. The electronic device of claim 4 wherein said one or more buttons are adapted to activate a particular call for the same species of animal.

6. The electronic device of claim 5 wherein said buttons comprise a first button and a second button, said first button being adapted to activate a first call of a particular species of animal and said second button being adapted to activate a second call of said species of animal.

7. The device of claim 6 wherein the device is adapted to interrupt the first call and play said second call when said second button is activated.

8. A method of facilitating the reproduction of wildlife calls comprising:
storing digital audio sounds comprising a plurality of different calls for the same particular species of animal within a memory;
coupling an activator means to said memory adapted to play said one or more different calls.

9. The method of claim 8 further comprising coupling a speaker to said memory means.

10. The method of claim 9 wherein said plurality of different calls for the same particular species of animal comprises at least two of a lost call, assembly call, greeting call, alarm call, feeding call, yelp, cluck, purr, hail call, come back call and safety call.

11. The method of claim 10 wherein said memory means coupled to said memory comprises one or more buttons.

12. The method of claim 11 wherein said one or more buttons are adapted to activate a particular call for the same species of animal.

13. The method of claim 12 wherein said buttons comprise a first button and a second button, said first button being adapted to activate a first call of a particular species of animal and said second button being adapted to activate a second call of said species of animal.

14. The method of claim 12 further comprising pressing said second button and interrupting said first call by said second call.

15. A method of training to reproduce various wildlife calls of the same species of animal comprising:
playing a first wildlife call of a species of animal using the electronic device of claim 1;
playing a second wildlife call of a species of animal using the electronic device of claim 1;
repeating at least one of said first and second call.
